(19) United States
(12) Patent Application Publication
(10) Pub. No.: US 2003/0172533 A1
(43) Pub. Date: Sep. 18, 2003

(54) Scissors type element for sectioning and retaining a candle wick

(76) Inventor: Pamela K. Alexander, Goodrich, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/098,962

(22) Filed: Mar. 15, 2002

(51) Int. Cl. B26B 13/00

(52) U.S. Cl. 30/131; 30/233

(57) ABSTRACT

A scissor-type implement for use in removing a trailing end of a candle wick. The implement includes first and second elongated handle portions pivotally connected together at an intermediate location and each terminating in an opposing and inter engaging wick sectioning and storage member. Each of the wick sectioning and storage members includes a substantially semi-spherically bell shaped and interiorly hollowed housing. First and second incisor portions extend from the hollowed interior of associated housings and each includes an overlapping and angled blade edge. Upon the housing members first being partially displaced relative one another and arrayed around the wick, the handle portions are actuated in mating fashion. The overlapping blade edges successively grip the wick and section its trailing end in angular fashion from a remaining portion of the wick, the sectioned wick end being retained within a selected one of the matingly engaged housings.

### BACKGROUND OF THE INVENTION

1. Field of the Invention

The present invention relates generally to candle wick trimming devices. More particularly, the present invention discloses a scissor-type wick trimming implement which exhibits bell-shaped opposing and inter-engaging portions for successively sectioning and retaining a candle wick. In particular, the present invention is uniquely suited to re-fashion a desired trailing length (typically ¼″) of a candle wick recessed inside a partially melted candle, such a wick usually further exhibiting a desired angled end after sectioning.

2. Description of the Prior Art

The prior art is fairly well documented with prior art examples of wick trimming devices. The objective in each instance is to substitute the use of scissors, tweezers or other known implements with a device more particularly suited for sectioning a new or partially burnt candle wick to retain a desired remaining length of the wick for subsequent relighting of the candle. In the particular instance of scissors, it has typically found that they have to be angled in order to section a trailing end of the candle wick and, given further the degree to which the wick may be recessed within a previously burnt candle, adequate sectioning of the wick is often difficult to accomplish.

A first example of the prior art is illustrated in U.S. Pat. No. 6,243,954, issued to Bowers, and teaches a wick trimming device incorporating a pair of elongated jaw members extending from scissor shaped handle portions. Cooperating severing surfaces are arranged in spaced fashion from the lower ends for severing the candle wick a predetermined height above the candle. The severing surfaces include a pair of opposing recesses defined between the jaw members, for receiving and retaining the extending candle wick, as well as an inwardly directed and tapered severing shelf disposed above one of the selected and recessed vertical faces.

U.S. Pat. No. 6,321,453, issued to Pappas, teaches a wick trimmer which, referring in particular to the second variant of FIGS. 12-17, includes blades, arms, and an engaging pivot for rotatably securing the arms together. In the further variant of FIG. 17, the second plate is replaced by an anvil. Also illustrated are gauge fingers and which (referring to the further variant of FIGS. 15 and 16) may be rotatably attached to the wick trimming device. As further explained, the gauge finger rests on the wax surface of a candle and so that the wick of the candle passes between the blades prior to being sectioned.

Finally, U.S. Pat. No. 6,209,207, issued to Patterson, teaches a hand held candle wick cutting device which includes a main outer tube and an inner tube with an outer diameter slightly smaller than the inner diameter of the outer tube and so that the inner tube is rotatably installed within the outer tube. A pair of cutting blades are mounted to the outer and inner tubes in perpendicular fashion relative and along the longitudinal axis and so that, upon rotating the tubes relative to one another, an inserted candle wick is severed and retained within the inner tube for subsequent removal and disposal.

### SUMMARY OF THE PRESENT INVENTION

The present invention is a scissor-type wick trimming implement which exhibits bell-shaped opposing and inter-engaging portions for successively sectioning and retaining a candle wick. In particular, and as previously explained, the present invention is uniquely suited to re-fashion a desired trailing length (typically ¼″) of a candle wick recessed inside a partially melted candle, such a wick usually further exhibiting a desired angled end after sectioning.

The scissor-type implement includes first and second elongated handle portions, each of the handle portions having a looped scissor end and being pivotally connected together at an intermediate location by such as a rivet or other suitable fastener to permit pivoting of the first and second elongated portions. The handle portions each further terminate in an opposing and inter engaging wick sectioning and storage member. Each of the wick sectioning and storage members further including a substantially semi-spherical shaped and interiorly hollowed housing with a base extending surface. In particular, the semi-spherical shape may further include a substantially arcuate and bell shaped configuration.

Each of the sectioning and storage members further includes an incisor portion and, in particular, a first incisor portion extends from the hollowed interior of a first housing member and in a direction towards a second incisor portion extending likewise from the interior of the second housing member. Each of the incisor portions further includes an upwardly extending support which in turn is secured to an enclosing base surface of an associated housing member, each of the incisor portions further including an overlapping and angled blade edge.

In use, the housing members are initially partially displaced relative one another and arrayed around the wick. The handle portions are then actuated in mating fashion, such that the overlapping blade edges successively grip the wick and section its trailing end in angular fashion from a remaining upstanding portion of the wick, the dimensions of which are again preferably in the range of ¼″. The sectioned wick end is retained within the enclosure defined by the mating housing members and during subsequent retraction and removal from such as a recessed location within which the candle may be situated. It has also been found that an angularly incised end of the remaining candle wick, in use, produce an improved and more aesthetically appealing flame.

### BRIEF DESCRIPTION OF THE DRAWINGS

Reference will now be had to the attached drawings, when read in combination with the following detailed description, wherein like reference numerals refer to like parts throughout the several views, and in which:

FIG. 1 is a first perspective view of the scissor-type implement according to a preferred embodiment of the present invention;

FIG. 2 is an exploded view of the scissors implement of FIG. 1 and further illustrating the interiorly hollowed configuration of the first and bell shaped and wick incisor portions;

FIG. 3 is a partial cutaway view of the scissors implement in use and illustrating the manner in which the opposing angled blades are arrayed on opposite sides of the wick to be sectioned; and

FIG. 4 is a second partial cutaway similar to that illustrated in FIG. 3 and illustrating the succeeding and mating overlap of the opposing angled blades and the manner in which they successively section and retain a trailing edge portion of the candle wick within the enclosed chamber defined between the mating halves.

### DESCRIPTION OF THE PREFERRED EMBODIMENT

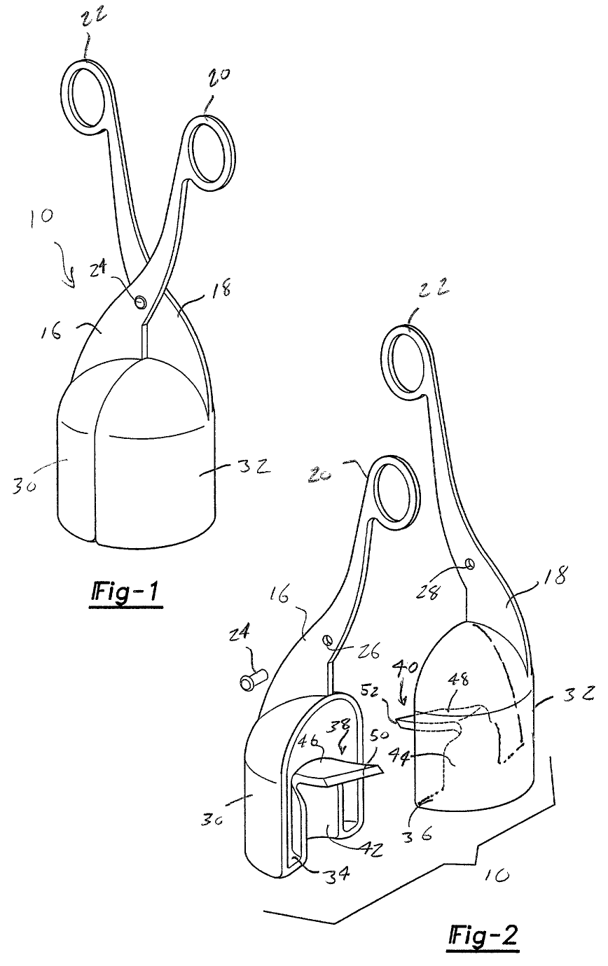

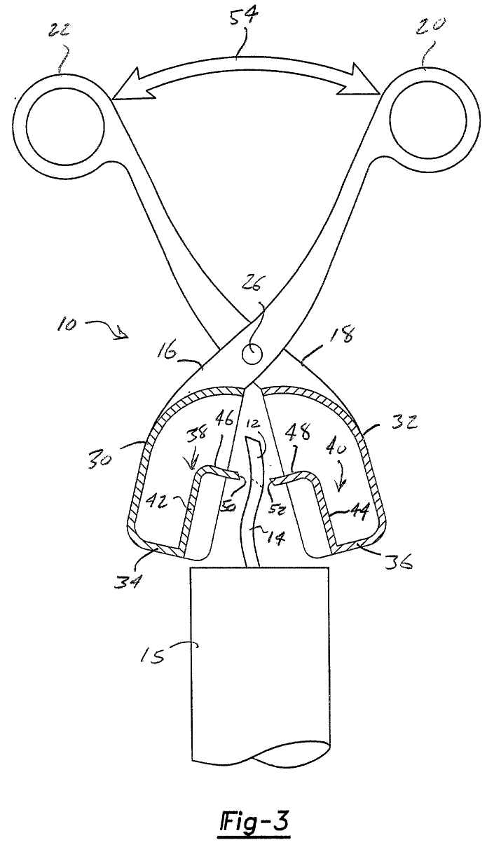

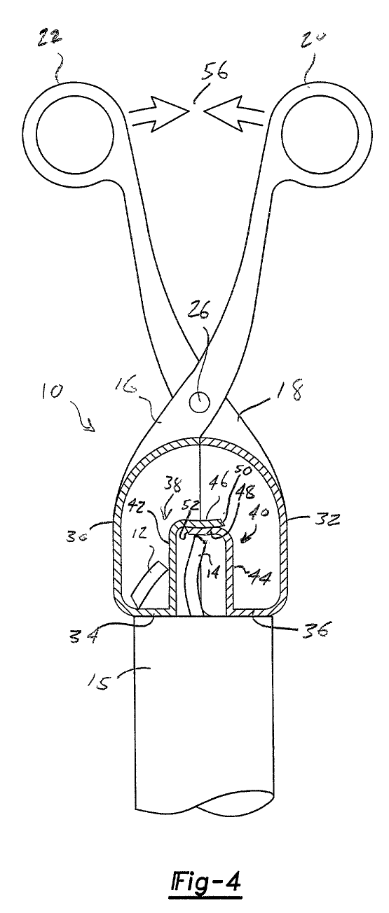

Referring now to FIG. 1, a scissor-type implement is illustrated at 10 according to a preferred embodiment of the present invention and which is useful in removing a trailing end 12 of an existing candle wick 14 (see also FIG. 4). In particular, and as previously explained, the present invention is uniquely suited to re-fashion a desired trailing length (typically ¼″) of a candle wick recessed inside a partially melted candle (the candle also being referenced at 15 in FIGS. 3 and 4), the wick 12 usually further exhibiting a desired angled end after sectioning (again FIG. 4).

As also previously explained, the implement 10 of the present invention makes possible the sectioning of an excessive length of a wick and in which the candle is situated in a recessed manner, such as within a tall glass enclosure or the like. It has also been found that an angularly incised end of the remaining candle wick, in use, produces an improved and more aesthetically appealing flame.

Referring again to FIG. 1, as well as to each of the succeeding FIGS. 2-4, the scissor-type implement includes a first 16 and a second 18 elongated handle portion. Each of the handle portions 16 and 18 is constructed of a suitable material, such as a metal or other durable and heat resistant material. Each of the handle portions 16 and 18 includes in the preferred variant a looped scissor end, see at 20 and 22 respectively for handle portions 16 and 18.

The handle portions 16 and 18 are further pivotally connected together at an intermediate location and, as illustrated, this is accomplished by such as a rivet 24, or other suitable fastener, which inserts through aligning apertures 26 and 28 defined in the handle portions 16 and 18 and which permits pivoting of the elongated handle portions about a generally centrally defined axis. As is again evidenced by the designations 16 and 18 for the handle portions, each further includes a somewhat widened intermediate portion at its pivotally securing location, this permitting the proper dimensioning of the wick sectioning and retaining portions as will now be described.

As also illustrated in FIGS. 1-4, the handle portions 16 and 18 each further terminate, at an end opposite the associated looped scissor ends 20 and 22, in an opposing and inter engaging wick sectioning and storage member. In a preferred illustrated variant, each of the wick sectioning and storage members is further defined by a substantially semi-spherical shaped and interiorly hollowed housing, and reference is made to first housing 30 associated with the first handle portion 16 and second housing 32 associated with the second handle portion 18.

Each of the first and second housings 30 and 32 include a semi-spherical, and preferably substantially arcuate and bell shaped, configuration and which further defines an open and substantially hollow interior. As also best illustrated in FIGS. 2-4, a base surface, see at 34 and 36, is provided for each of the housings 30 and 32. Upon the three dimensional and bell shape of the housings 30 and 32 being matingly engaged together, as best shown in the cutaway of FIG. 4, it defines an enclosed interior.

Each of the sectioning and storage members (again referenced by the three dimensional and preferably bell shaped housings 30 and 32) further includes an incisor portion. In particular, a first incisor portion 38 extends from the hollowed interior of the first housing member 30 and in a direction towards a second incisor portion 40 extending likewise from the interior of the second housing member 32.

According to the preferred configuration, each of the first and second incisor portions, generally referenced again at 38 and 40, further includes an upwardly extending support (see at 42 and 44). The supports 42 and 44, as best shown in FIG. 2, each include a three-dimensional and curved configuration and are secured to generally centralized locations of the associated and enclosing base surface 34 and 36 of the housing members 30 and 32. In this fashion, sealing of the collective three-dimensional enclosure established by the mating arrangement of the housing members 30 and 32 (see FIG. 4) is maintained.

Referring again to FIGS. 2-4, each of the incisor portions 38 and 40 further includes an overlapping blade with angled blade edge and reference is made to first blade 46, secured to an upper end of support 42, and second blade 48, likewise secured to an upper end of support 44. As illustrated, the blades 46 and 48 extend in substantially perpendicular fashion relative to their upwardly extending supports, and in directions towards each other, so as to establish a substantially mating and overlapping relationship upon being actuated to the arrangement illustrated in FIG. 4.

As also illustrated, each blade includes a mirror angled blade edge and reference is made to angled blade edge 50 for first blade 46, as well as angled blade edge 52 for second blade 48. The angular orientation of the opposing blade edges 50 and 52 co-act, upon matingly engaging the housing members 30 and 32 together to the orientation of FIG. 4, to section the trailing end 12 of the candle wick and so that its remaining portion 14 exhibits the previously described and desired angular profile.

Referring finally again to FIGS. 3 and 4, the scissor type implement 10 is utilized to section a candle wick. Referring first to FIG. 3, the first and second handles 16 and 18 are first partially displaced relative one another and as shown by directional arrow 54 in association with the scissor ends 20 and 22. In this fashion, the associated housing members 30 and 32 are arrayed in opposing fashion around and on opposite sides of the wick 12.

Referring again to FIG. 4, the handle portions 16 and 18 are then actuated in mating fashion, such as shown by the direction of arrows 56 at associated scissor ends 20 and 22. At this point, the overlapping and angled blade edges 50 and 52 successively grip the wick and section its trailing end 12 in the desired angular fashion exhibited by its remaining upstanding portion 14. As previously described, a preferred application is to trim the remaining wick 14 to a dimension preferably in the range of ¼″. The sectioned wick end 12, as again referenced in FIG. 4, is retained within the enclosure defined by the mating housing members. In this fashion, and during subsequent retraction and removal from such as a recessed location within which the candle 15 may be situated, the sectioned wick end 12 is prevented from falling into the candle and such as in particular its upper melted wax layer.

Having described my invention, additional preferred embodiments will become apparent to those skilled in the art to which it pertains and without deviating from the scope of the appended claims. In particular, and without limitation, the three-dimensional housing members, with retained incisor portions, may be shaped in any suitable and enclosing fashion for accomplishing sectioning and retaining of the sectioned wick end.

I claim:

1. A scissor-type implement for use in removing a trailing end of a candle wick, said implement comprising:
first and second elongated handle portions pivotally connected together at an intermediate location, each of said handle portions terminating in an opposing and inter engaging wick sectioning and storage member; and
upon said members being partially displaced relative one another and arrayed around the wick, said handle portions being actuated to successively grip, section and retain the trailing edge portion.

2. The scissor-type implement as described in claim 1, each of said wick sectioning and storage members further comprising a substantially semi-spherical shaped and interiorly hollowed housing.

3. The scissor-type implement as described in claim 2, further comprising at least one incisor portion extending from a selected housing.

4. The scissor-type implement as described in claim 3, further comprising a first incisor portion extending from said first housing and in a direction towards a second incisor portion extending from said second housing.

5. The scissor-type implement as described in claim 4, said first and second incisor portions each further including an overlapping and angled blade edge.

6. The scissor-type implement as described in claim 5, each of said housings further comprising a base surface from which extends a support of an associated incisor portion.

7. The scissor-type implement as described in claim 2, each of said semi-spherical shaped members having a selected shape and size and further comprising a substantially arcuate and bell shape configuration.

8. A scissor-type implement for use in removing a trailing end of a candle wick, said implement comprising:
first and second elongated handle portions pivotally connected together at an intermediate location, each of said handle portions terminating in an opposing and inter engaging wick sectioning and storage member, each of said wick sectioning and storage members further comprising a substantially semi-spherical shaped and interiorly hollowed housing;
a first incisor portion extending from said substantially hollowed interior of first housing and in a direction towards a second incisor portion extending from said substantially hollowed interior of said second housing, each of said incisor portions further comprising an overlapping and angled blade edge; and
upon said members being partially displaced relative one another and arrayed around the wick, said handle portions being actuated in mating fashion, said overlapping blade edges successively gripping the wick and sectioning its trailing end in angular fashion from a remaining portion of the wick, the sectioned wick end being retained within a selected one of the matingly engaged housings.

9. A scissor-type implement for use in removing a trailing end of a recessed candle wick, said implement comprising:
a first and a second elongated handle portion, each of said handle portions further including a looped scissor end and are pivotally connected together at an intermediate location;
each of said handle portions terminating in an opposing and inter engaging wick sectioning and storage member, each of said wick sectioning and storage members further comprising a substantially semi-spherical shaped and interiorly hollowed housing with a base extending surface;
said sectioning and storage members each further comprising a first incisor portion extending from said substantially hollowed interior of first housing and in a direction towards a second incisor portion extending from said substantially hollowed interior of said second housing, each of said incisor portions extending substantially upwardly from an associated base surface and each further comprising an angled and overlapping blade edge; and
upon said members being partially displaced relative one another and arrayed around the wick, said handle portions being actuated in mating fashion, said overlapping blade edges successively gripping the wick and sectioning its trailing end in angular fashion from a remaining portion of the wick, the sectioned wick end being retained within a selected one of the matingly engaged housings.
